(19) United States
(12) Patent Application Publication
(10) Pub. No.: US 2010/0129176 A1
(43) Pub. Date: May 27, 2010

(54) SCREW HEAD RECESS DRIVE AND CORRESPONDING DRIVER TOOL AND RECESS PUNCH

(75) Inventor: Balasingam Karupaya, Negeri Sembilan (MY)

Correspondence Address: KNOBBE MARTENS OLSON & BEAR LLP, 2040 MAIN STREET, FOURTEENTH FLOOR, IRVINE, CA, 92614, US

(73) Assignee: Unisteel Technology International Limited, Labuan F.T, (MY)

(21) Appl. No.: 12/598,586

(22) PCT Filed: Apr. 30, 2008
(86) PCT No.: PCT/SG08/00148

§ 371 Date: Nov. 2, 2009

(30) Foreign Application Priority Data
May 2, 2007 (SG) 200703158-6

(51) Int. Cl. F16B 35/06; B25B 23/00; B21J 13/00

(52) U.S. Cl. 411/404; 81/460; 470/205

(57) ABSTRACT

A fastener with a recess head wherein the drive head has four lobular recess channels. Each channel comprises a first wall, a second wall, a bottom surface and a recess sidewall. The first and second walls have portions opposing each other and a constant radius of curvature to form a continuously and smoothly forming wall of the channel. A torque producing driver tool is defined with cross sectional signature substantially complementary in size and shape of the recess of the drive head of the fastener for matable engagement. A recess punch for manufacturing the fastener is also defined and comprises a punch holder and a punch pin integral with the holder.

### FIELD OF THE INVENTION

This invention relates to screw head recess drives and corresponding driver tool or bit capable of engaging with the screw head recess drive of a screw.

### BACKGROUND OF THE INVENTION

Drive systems for all types of miniature screws typically for custom low profile head height product sizes range from about 0.4 mm through about 2.0 mm are conventionally used for special purpose applications. In such applications, threads and head height of the screw are custom designed to meet specific quality and functional requirements in joints. For example, when designs of screw head height are thinner than industrial standards, such as for example Japanese Camera Industrial Standard (JCIS), American National Standards Institute (ANSI), German Institute for Standardization (DIN) or International Organization for Standardization (ISO), deeper recess depth is required to achieve and transmit higher torque in joints. Another example is when assembling joints with thread forming screws which have high prevailing torque, the recess drives and driver tools need to withstand and transmit higher torque during the installation for such applications.

However, current conventional drive recesses and/or driver tools are unsuitable for situations where both quality and functional needs for installation are required and extra reliability and characteristic for miniature product and process applications. Some typical functional requirements required are: compatibility to automated assembly solution; higher driver bits life cycle; no cam-out of driver bits during assembly; high torque transmission in recess and driver bits; temper resistant characteristic; variability of size selection; application for ultra thinner head height for miniature screw; high failure torque; no drive stick-fit; or eliminate recess stripping.

However, as mentioned above, the conventional drive systems do not adequately meet all or some of the above listed of the functional requirements. For example, some previous screw head recesses that have been disclosed include U.S. Pat. No. 6,253,649, U.S. Pat. No. 4,084,478, U.S. Pat. No. 4,202,244, U.S. Pat. No. 5,120,173, and U.S. Pat. No. 5,137,407. These previous screw head recess configurations have been employed and adopted in many countries as “the recess” to be formed in some types of screw heads, and now have spread worldwide. Although these previous screw head recess drives afford sure transmission of torque by virtue of their crossing recesses, and the driver bits fit in the recesses snugly and firmly, thereby improving operation efficiency in tightening or removing screws, there have arisen certain problems in particular relating to electrical device manufacturing where manufacturers are moving to miniaturization of their product, which directly has an impact on fasteners size to be designed with special quality, functional and reliability to meet the application needs which are higher than that of current industrial standards. This failure typically occurs for product sizes range from about 0.4 mm up to about 2.0 mm.

Most conventional screws are designed with extremely low head height for example about 0.20 mm. Such low head height does not provide sufficient recess depth to transmit sufficient torque in many applications. Conventional screws in these applications have a functional limitation that is does not meet the functional requirements in the industry. Therefore, there is a need in the art for recess drive screw head and corresponding driver that addresses a problem associated with the prior art.

### SUMMARY OF THE INVENTION

In accordance with an aspect of the invention, a screw with a recess head and corresponding driver bit are disclosed, wherein the head has a plurality of lobular recess channels for receiving a torque from the driver bit. In accordance with an embodiment a fastener is disclosed comprising a head, the head having a top surface and an axis; and a drive, the drive defined by a lobular recess centrally aligned with the axis of the head, the recess formed by a plurality of recess channels disposed on the top surface of the head and radially aligned and symmetrically arranged with the axis of the head, each channel comprising a first wall, a second wall and a bottom surface and a recess side wall, the first and second walls having portions opposing each other and having a constant radius of curvature, the recess side wall having a surface vertically disposed and extending to the deepest point of the recess from the top surface of the head meeting the bottom surface of the recess; the other end of the bottom surface abuts the first wall, second wall, and side wall continuously and smoothly forming the wall of the channel.

In an embodiment, the plurality of channels the first wall of each channel continuously and smoothly forms a wall with the second wall of an adjacent channel. A surface of recess side wall is substantially perpendicular with the top surface of the drive head. A surface of recess side wall may be tapered with the top surface of the drive head. In the fastener the head may be arranged in a substantially circular shape that defines a radius of the head. The top surface of the head may be substantially flat. The plurality of channel recesses may comprise four channel recesses. The fastener may further comprise a head to shank material ratio from the recess side wall to the side wall of the head of the fastener is arranged to maximize breaking torque. The head to shank material ratio may be at least 1:1. The recess has a recess depth and the fastener has a head height, wherein the head height is less than the recess depth. The head height may be in the range of 0.1 mm and of the recess depth. The head height may be in the range of 0.2 mm and the recess depth is 0.28 mm. The fastener may comprise a major diameter ranging from 0.4 mm to 2.0 mm, and a respective recess depth ranging from 0.28 mm to 0.80 mm. The first wall and second wall may be inner lobes and the recess side wall is an outer lobe. The radius of the first and second inner lobe walls may each equal with the radius of the recess side out lobe wall

In another aspect of the invention, a torque-producing driver tool for operating the fastener is disclosed, the tool comprises a handle; and a shank having a first end and a second end, the first end of the shank connected to the handle, and the second end of the shank having cross sectional signature substantially complementary in size and shape to the four recessed channel of said head of the fastener for matable engagement with the recess drive of the fastener. In an embodiment, the driver tool is arranged to have a zero degree drive angle when in engagement with the recess drive of the fastener.

In another aspect of the invention, a recess punch for manufacturing the fastener is disclosed, the recess punch comprising a punch holder; and a punch pin having a first end and a second end, the first end of the punch pin for having a cross-sectional signature substantially complementary in size and shape to the recess the drive of the head of the fastener for punching the recess into the head of the fastener to manufacture the recess drive of the fastener. In an embodiment the second end of the punch pin is integral with the punch holder. In another embodiment the punch holder has a receiving aperture for receiving the punch pin wherein the punch pin is slidebly engaged with the punch holder through the receiving aperture.

### BRIEF DESCRIPTION OF THE DRAWINGS

In order that the present invention may be fully understood and readily put into practical effect, there shall now be described by way of non-limitative example only embodiments of the present invention, the description making reference to the accompanying illustrative drawings.

In the drawings:

FIGS. 1A and 1B shows a top perspective view of a screw head in accordance with an embodiment of the invention;

FIG. 2A-D, where FIG. 2A shows a side cross sectional view of the screw of FIG. 1A, FIG. 2B shows a top perspective view of the screw head of FIG. 2A, FIG. FIGS. 2C and 2D are cross sectional views taken along lines A-A, and B-B, respectively, of FIG. 2B in accordance with an embodiment of the invention;

FIG. 3A-F, where FIG. 3A shows a side perspective view of a driver tool in accordance with an embodiment of the invention, FIG. 3B shows an enlarged view of the portion of the driver tool taken from line B-B, and FIG. 3C shows a cross-sectional view taken along line B-B of the driver tool of FIG. 3A, FIG. 3D-3F shows the cross-sectional view taken along A-A and B-B in accordance with an embodiment of the invention;

FIG. 4A-B, where FIG. 4A shows a cross sectional view of the screw of FIG. 2A super imposed and engaged with a side perspective view of the driver tool of FIG. 3A, FIG. 4B shows a cross sectional view of driver tool taken along line A-A looking in direction of arrows in accordance with an embodiment of the invention;

FIG. 5A-F, where FIGS. 5A and 5B shows a top and side perspective view, respectively, of a recess punch, FIGS. 5C and 5E shows a top and side perspective view of a punch holder, and FIG. 5D shows perspective view of the punch pin and FIG. 5F shows the assembled punch pin and holder in accordance with an embodiment of the invention;

FIG. 6A-D, where FIGS. 6A and 6B show perspective and cross sectional views, respectively of “NO GO”, and FIGS. 6C and 6D show perspective and cross sectional view, respectively, of “GO” in accordance with an embodiment of the invention;

FIG. 7A-C, FIG. 7A shows a top perspective view of the tapered recess drive, and FIG. 7B shows the bottom perspective view, FIG. 7C shows the combination of both top and bottom view of the tapered recess drive and screw head in accordance with an embodiment of the invention;

FIG. 8A-E, where FIG. 8A shows a side cross sectional view of the screw of FIG. 7A, FIG. 8B shows a top perspective view of the screw head of FIG. 7A, FIG. FIGS. 8C and 8D are cross sectional views taken along lines A-A, and B-B, respectively, of FIG. 8B, and FIG. 8E shows a three dimensional view of the inner and outer walls of each recess channel curves in accordance with an embodiment of the invention;

FIG. 9A-B, where FIG. 9A shows a cross sectional view of the screw of FIG. 8A super imposed and engaged with a side perspective view of the driver tool of FIG. 10A, FIG. 9B shows a cross sectional view of driver tool taken along line A-A looking in direction of arrows in accordance with an embodiment of the invention;

FIG. 10A-H show side perspective views of a driver tool in accordance with an embodiment of the invention;

FIG. 11A-B show side and top perspective views, respectively, of recess punch in accordance with an embodiment of the invention; and

FIG. 12A-B shows side and top perspective views, respectively, of recess gauge in accordance with an embodiment of the invention.

### DETAILED DESCRIPTION

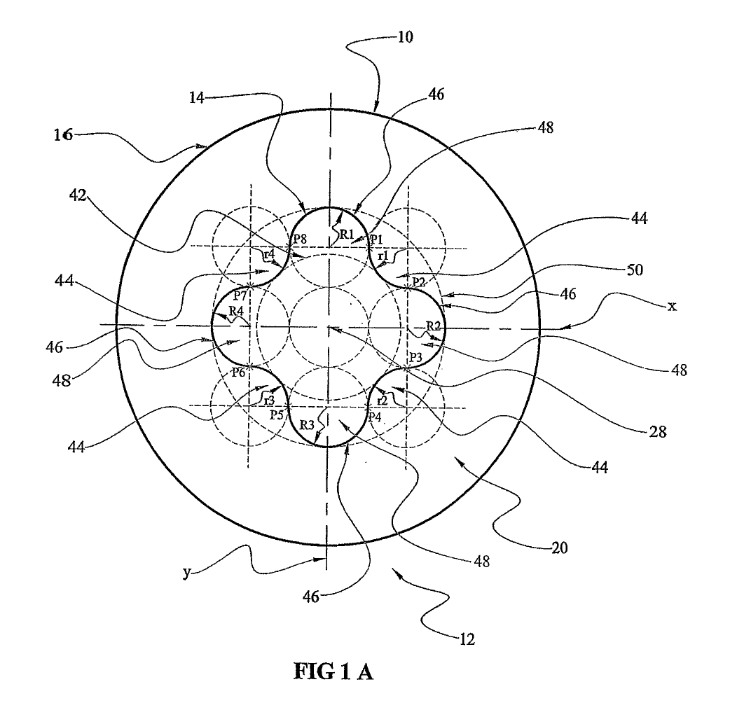

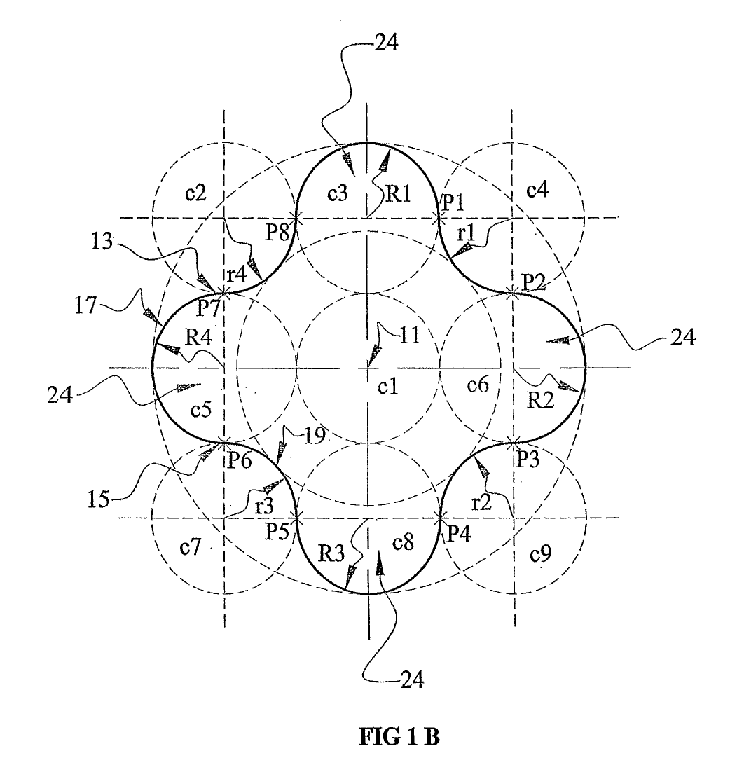

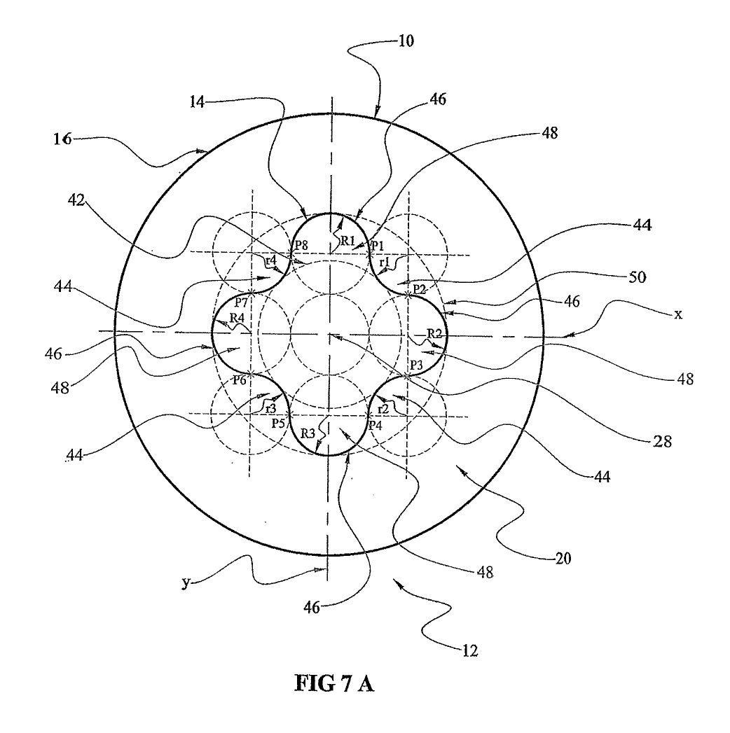

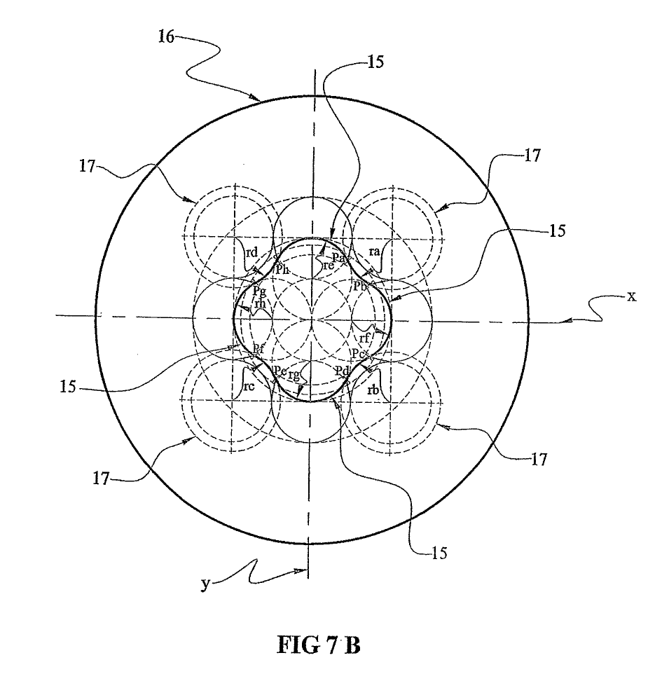

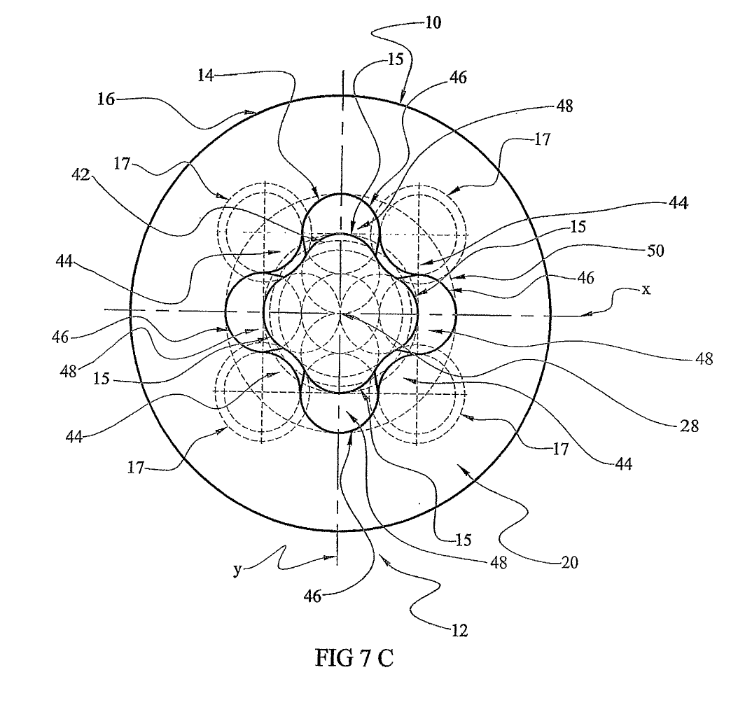

Embodiments of a screw head recess in screw heads in accordance with the invention are disclosed. In addition, corresponding driver tools or bits to match the recesses are disclosed. The recesses in the screw heads are suited to transmit a high torque, compatible for automation assembly, and are high drive bit cycle and high failure torque tolerant. The recessed screw head and a corresponding driver bit, are described having different side wall configurations. One embodiment shown and described is a lobular recess drive embodiment having a straight wall configuration, as shown in FIG. 1-6. Another embodiment shown and described is a lobular recess drive embodiment having a tapered wall configuration, as shown in FIG. 7-12.

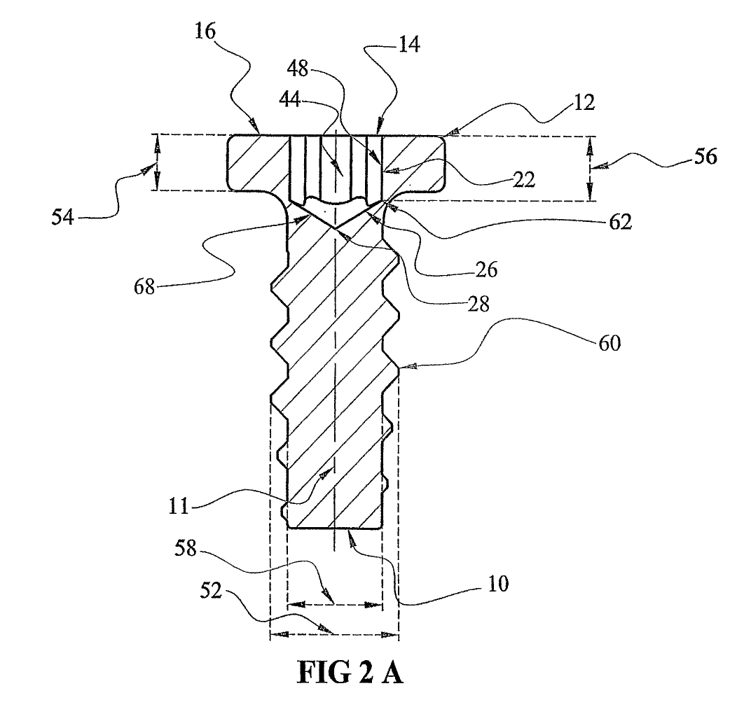

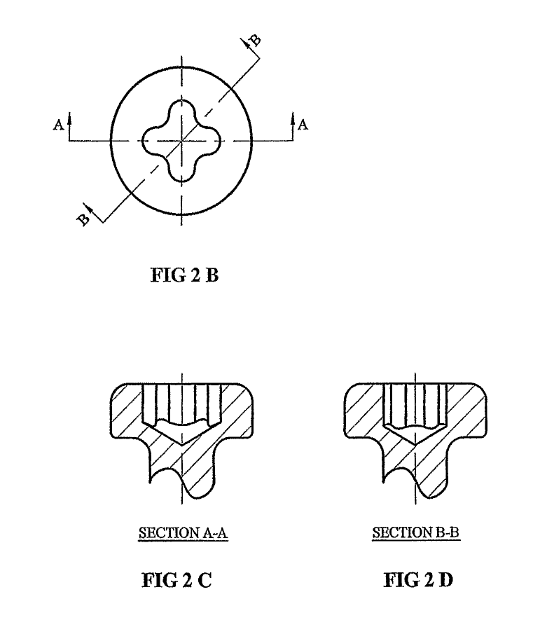

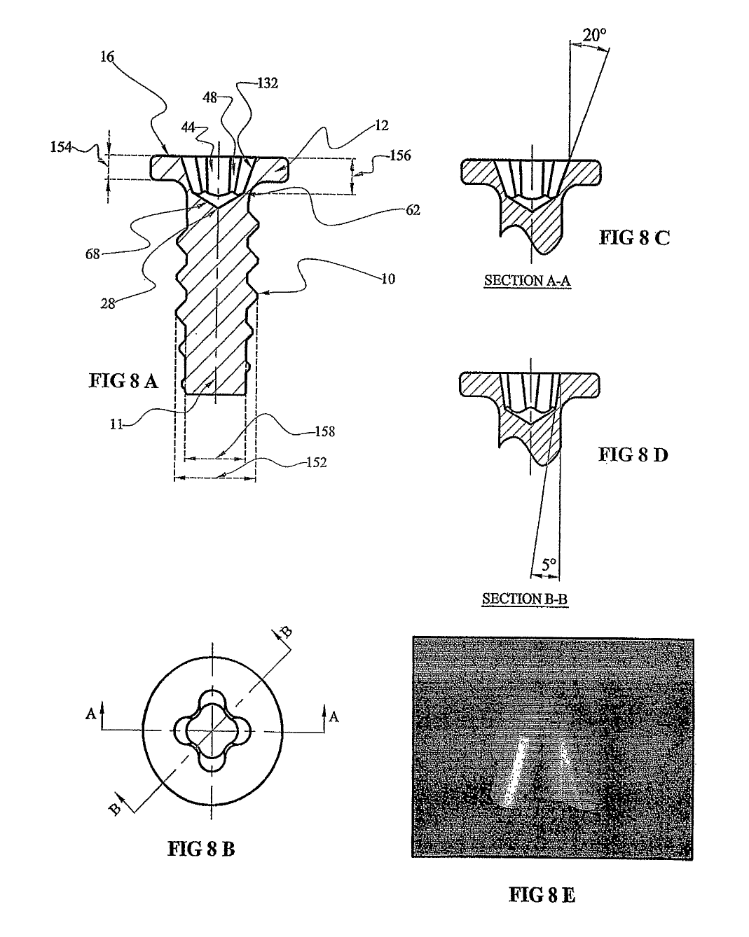

In the embodiments, the basic geometry and configuration of the top surface 16 are the same, as shown in FIG. 1A. However, the recess shapes in the embodiments are sculpted and adapted to transmit a high torque while also affording a larger cross sectional area of recess and driver bit with non-sticking characteristic, where the outer and inner lobes are smoothly shaped or sculpted curves without any sharp edges which eliminates sticking of the drive to the driver thus providing positive engagement. The basic geometry and configuration of the top surface are same. Both the tapered and non-tapered shapes described are nevertheless adapted to transmit a stronger torque and affording a larger cross sectional area of recess and driver bit with non sticking characteristic thus providing positive engagement. With the taper drive embodiment with respect to the drive with straight wall allows the feasibility to apply in applications of ultra low profile head height (for example, 0.2 mm) with deeper recess depth (for example, 0.28 mm). This configuration lowers cost of product manufacturing because the cost of manufacturing tools, dies, gages, etc. may be kept lower than in conventional applications. In addition, this configuration helps reduce possible material folds in recess and improve driver bit contact and maximize engagement. Also, with this configuration, a high head to shank material ratio is maintained with a minimum ratio of 1:1 even at minimum and maximum material conditions applies to the product head height and or the recess depth, which maintains quality and durability of the screw head drive. The head to shank material ration is defined as the ratio from the recess side wall to the side wall of the head of the fastener as shown in FIGS. 2A and 8A to maximize breaking torque. Also, this configuration improves and extends the drive bits life cycle.

While the lobular recess drive with straight wall have an added characteristic which are capable to be applied in high tensile material series and custom made steel. It will be appreciated that any number of materials for the screw may be selected, for example, low carbon steel, stainless steel 300 and/or 400 series, aluminum, brass, titanium, other special high tensile material, other materials according to specification and application, and the like.

Shown in FIG. 1-6, lobular recess drive 14 with straight wall formed in a top of the screw head consists of central region 20 with four lobular grooves 24 or channels extending radially and continuing from said central region. The grooves extended deeper towards bottom of the screw head until point 62, which defined as the effective recess depth 56 and 156 for both type of embodiment, as shown in FIGS. 2A and 8A respectively, and tapered conically 26 and meet at a center point 28 at the bottom of the recess. Specifically, each channel is defined by inner lobes 44, outer lobes 48 and the bottom of the recess 28. The first wall curves to radial end points, which lie between two arcs, and the end points are 90 degrees away from each other relative to the center point. The first wall defined by the vertical inner lobe 44 of each channel smoothly curves equally as the vertical inner lobe extends to the endpoint. Similarly, the outer vertical lobes 48 defines the second wall of each channel also smoothly curves and extends out to meet and join the endpoint of the first wall. The radius of the first and second wall 22 is equal when nominal dimension are applied to the basic construction circles. The top surface of the head is preferably flat or circular and the bottom surface of each of the channels tapered and meets at the common endpoint 28 of the channel.

It will be appreciated that the lobular recess drive with a straight wall configuration may have as an option of conversion and adaptability for temper resistance, axial auto-insertion of driver bits, combination of full and half slot features which providing a competitive advantage for designers with choices which does not limit the customers needs and manufacturing of tools, moulds and gages.

Referring to FIGS. 1A and 1B, the basic geometry of the screw recess lobular recess drive with straight wall configuration is constructed with 9 equal circles (c1-c9), with 3 circles arranged horizontally and 3 circles arranged vertically, in 3 rows. The center point of inner circle 42 creates the inner lobes 44 having radius r1, r2, r3, r4, respectively, and the center point of outer circle 46 which creates the outer lobes 48 has R1, R2, R3 & R4 and connects points P1, P2, P3, P4, P5, P6, P7 & P8. The inner lobes 44 are constructed in a manner described below; r1 connects P1 & P2, r2 connects P3 & P4, r3 connects P5 & P6, and r4 connects P7 & P8.

In this embodiment, the outer lobes 48 are constructed in a manner described below. R1 connects P8 & P1, R2 connects P2 & P3, R3 connects P4 & P5, R4 connects P6 & P7. While circle 50 is the major diameter of the recess, circle 50 is also the minor diameter of the recess of the inscribed circle, and circle 42 is the minor diameter of the recess. Point 28 is the center point of the recess drive. The angle between each lobe is 90 degrees apart.

Referring to FIG. 2A-D, in FIG. 2A a fastener 10 which is in accordance with an embodiment of the present invention comprises a head 12 and a conventional threaded shank 60 (only a portion of which is shown in the figures) which is major diameter 52 range from, for example 0.4 mm-2.0 mm, and recess depth 56 range from, for example 0.28 mm-0.80 mm, respectively, and can be expandable further in ranges, perpendicularly connected to the bottom side of head 12. FIG. 2A shows a screw or fastener having size 52 defined by the threads of the screw or major diameter of the threads, with recess depth 56 that is deeper relative to the head height 54, relative to the shank size 58 of the screw. The head to shank ratio is maintained with a ratio that is greater than 1:1 to maximize breading torque. As indicated, the head to shank material ratio is defined as the ratio from the recess side wall to the side wall of the head of the fastener as shown in FIGS. 2A and 8A to maximize breaking torque. The fastener has a central axis 11. In the embodiment illustrated in FIG. 2A, the circular and substantially flat head 12 has four recess channels milled into the top surface 16 of the head 12 having center point. The circular shape of the screw head defines a radius of the head. The recess has a bottom side and formed by a plurality of channels disposed on the top surface of the head. In this embodiment, there are four channels as shown in FIG. 2B that are symmetrically arranged on said top surface of said head that form the recess. The inner and outer lobes have vertical straight wall 22 connect bottom side of point 62 which will be referred as effective recess depth. The cross-section A-A taken along the from outer lobe extremity to other outer lobe extremity is shown in FIG. 2C, while the cross-section B-B taken along the inner lobe innermost point to other lobe innermost point is shown in FIG. 2D. Taper point 68 has an angle of 120 degrees that joints from bottom point of 62 with inner and outer lobes towards end point 28. The end point or center point 28 is the deepest with respect to the top surface 16 of the fastener, and the gauging point where the recess depth are measured. The gauging point is from the top of the screw head 16 and to the lowest point 62. The inner and outer vertical walls 22 of each recess channel curves shown as three dimensional image of FIG. 8E such that torque from a corresponding driver tool are transmitted and be applied in both directions for installation and removal of screw. It will be appreciated that the top surface may have other configurations other than flat or circular, such as for example, rounded, concave, convex or the like, and/or square hexagonal or the like, respectively.

In an embodiment, each channel comprises an inner and outer wall, a bottom pointed end, and the channels radially curve outwards from the center points of the head. The inner and outer wall has a substantially ‘straight wall’ configuration and ‘taper wall’ configuration relative to the bottom point. At the bottom point the inner and outer wall have a constant radius of curvature, which may be equal at nominal material condition. In other words, the surface of the inner wall may smoothly curve inward at the specific radius of curvature as the curve extends to the endpoint. The radius of curvature is the radius of inner and outer lobes as same at nominal material conditions. The surface of the outer wall smoothly curve outward at the same radius of curvature as the curve extends to and converges to meet the surface of the outer lobe at the endpoint. The screw head drive recess has a recessed circular straight wall and taper wall surface disposed at the center endpoint. The circular straight and taper wall surface is vertically disposed at the deepest point with respect to the top surface of the head; and the bottom surface of each channel rises linearly from the center of the head to the endpoint of each channel.

The head includes of recess comprised of a plurality, for example four lobular channels, with a geometry eliminates sharp edges and corners preventing from stick fit and also feasibility to manufacture moulds which are able to withstand higher tool life. The channels meet at the center point at the bottom of the recess. Specifically, each channel curves to a radial end point, which lies between two arcs, and the end points are 90 degrees away from each other relative to the center point. The vertical inner lobe wall of each channel smoothly curves equally as it extends to the endpoint. Similarly, the outer lobe vertical wall of each channel also smoothly curves outward as it extends out to meet and join the endpoint of the inner wall. The radius of the inner and outer lobes wall is equal when nominal dimension are applied to the basic construction circles.

The top surface of the head is preferably flat or circular and the bottom surface of the head is flat or tapered. A lobular recess drive with straight and taper wall and driver tool with complementary driver head contact for operating the same. A threaded shank extends from a head such that they are integrally and perpendicularly connected. The head includes a plurality of (4) four circular recess channels on top surface and with a straight and tapered vertical wall, which meets at the bottom of the recess, and curve radially to a common center point.

In an embodiment, each circular recess channel curves to a radial end point, which lies between two arcs, and each recess channels are 90 degrees apart from each other, which gives (4) four circular lobes in (4) four axis. The vertical outer wall of each channels are smoothly curves outward when it extends to the endpoint. The inner wall does the same and the radius for the inner and outer lobes wall are equal with nominal material condition and will differ based on minimum and maximum values of the basic circle diameter.

The lobular recess drive with straight wall embodiment formed in a top of the screw head consists of central region with four lobular grooves extending radially from and continuing from said region to thereby surround it. The channels meet at the center point at the bottom of the recess. Specifically, each channel curves to radial end points, which lie between two arcs, and the end points are 90 degrees away from each other relative to the center point. The vertical inner lobes of each channel smoothly curves equally as the inner lobes extend to the endpoint. Similarly, the vertical outer lobes wall of each channel also smoothly curves inward as the vertical outer lobe extends out to meet and join the endpoint of the inner lobe. The radius of the inner and outer lobes walls is equal when nominal dimension are applied to the basic construction circles. As discussed previously, the top surface of the head is preferably flat or circular and the bottom surface of each of the channels tapered and meets at the common endpoint of the channel, however it will be appreciated that the top surface may be other shapes. This will be based on customer specification and or standard head shape according to DIN, JCIS, ANSI, ISO, and the like.

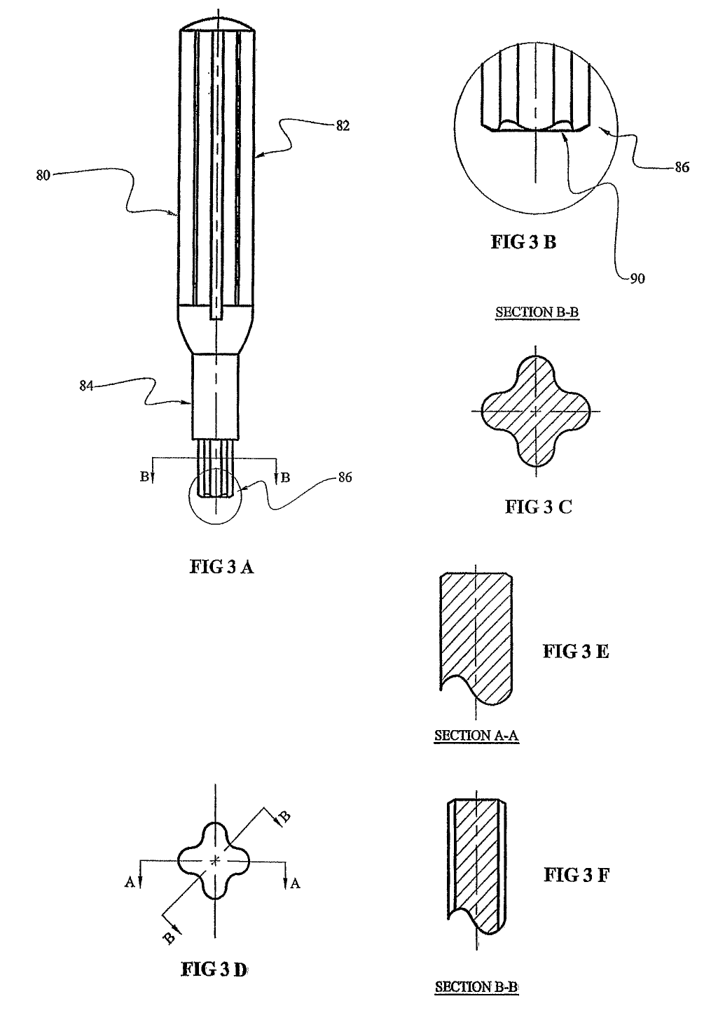

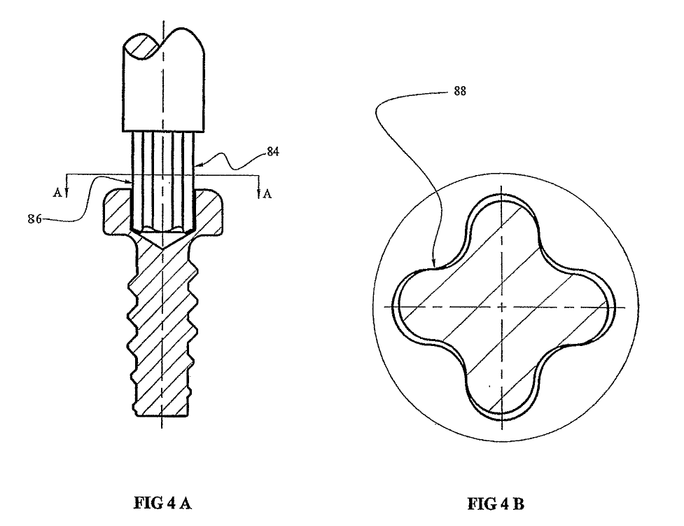

Referring to FIG. 3A-F, in FIG. 3A a driver tool 80 has a handle 82, shank 84 and a complementary driving contact 86. FIG. 3B shows the driving contact 86 in greater detail to show point 90 of the driver tool that is a flat end surface for driver bit. FIG. 3C is a cross-sectional view of the driving contact shown in FIG. 3A taken along line B-B. FIG. 3E-F is the cross sectional view which taken along line A-A and B-B from FIG. 3D. The torque producing driver tool has a shank with a cross-sectional signature substantially complementary in size and shape to the recess formed by the plurality of recessed channels, for example the four recess channels of the head of the fastener 10. When the shank is inserted into the recess, the shank aligns in a substantially matable engagement with the recess. It will be appreciated that any number of materials for manufacture of the driver may be selected as suitable material, for example, carbide, tool steel, other materials according to specification and application, and the like.

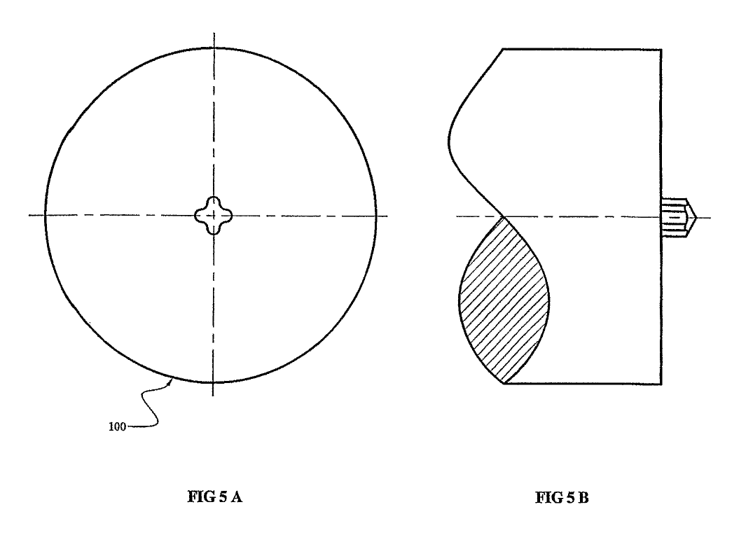

FIG. 4A is a cross-sectional view of the engage drive 10 of the screw of FIG. 2 and driver bit of FIG. 3A engaged which also illustrates that lobular recess drive with straight wall configuration having a zero drive angle. This configuration reduces the radial stress in the drive as well the driver and produce high transmission of torque for assembly. FIG. 4B shows a cross sectional view of a driver tool taken along A-A of FIG. 4A, and shows the drive bit and recess engagement showing a zero drive and driver angle contact 88 at zero degree.

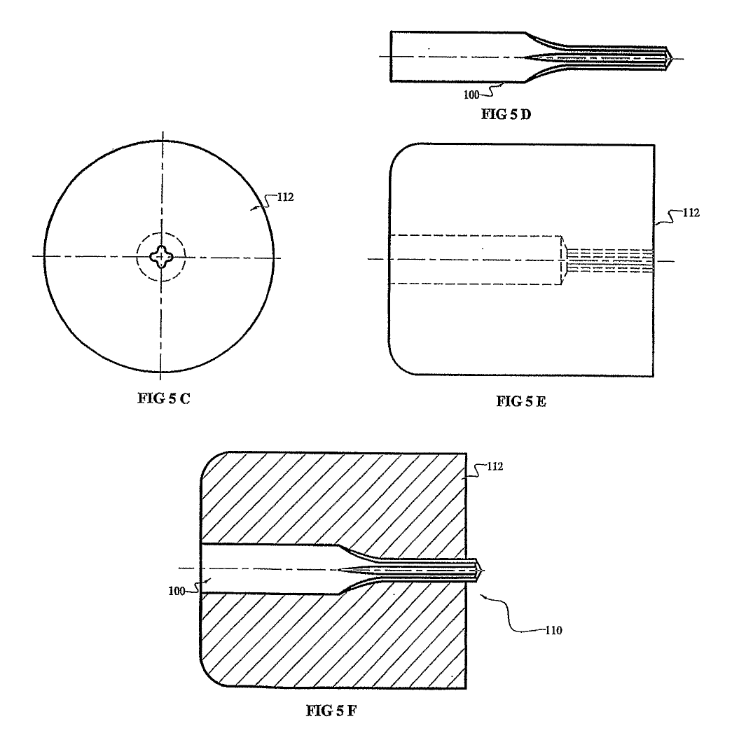

Referring to FIG. 5A-F, FIG. 5A-B shows a recess punch having a solid punch configuration 100 shown in FIG. 5C-5F, a punch pin 100 shown in FIGS. 5D and 5E a punch holder 112, 5C is the top view of the punch holder. FIG. 5F is the fully assembled punch pin and holder of the two piece punch 110. It will be appreciated that any number of materials for manufacture of the punch pin, holder and the punch configuration may be selected as suitable material, for example, high speed steel for example M42, other tool steel, other materials according to specification and application, and the like. Likewise, the punch pin may also be manufactured from the same or other suitable materials of the holder, for example, carbide, high speed steel for example M42, and the like.

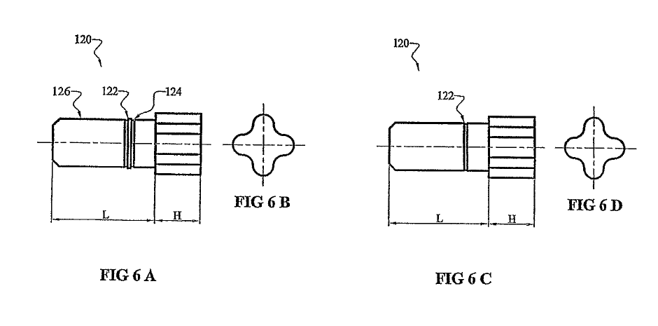

FIG. 6A-D, shows the GO and NO GO gauge to check the recess drive enable to make sure the lobular recess drive are manufactured according to specification and required tolerance. The NO GO 120 elements are to be identified two radial grooves 122, 124 on the shank 126 FIG. 6A. The GO gauge FIG. 6C are identified with one radial groove on the shank identity. FIG. 6B and FIG. 6D are the top view of both the GO and NO GO gauge.

Referring to FIG. 7A-C, the lobular recess drive with tapered wall embodiment is shown and the circumscribed configuration and geometry of the lobular recess drive with tapered wall is described. Similar reference numerals are used to refer to similar features described earlier with previous embodiments. FIG. 7A-C, FIG. 7A shows a top surface configuration of the tapered recess drive, and FIG. 7B shows the bottom perspective view, FIG. 7C shows the combination of both top and bottom view of the tapered recess drive and screw head in accordance with an embodiment of the invention. The recess channels for the recess drive are tapered 132 as it goes deeper to the bottom.

The lobular recess drive with tapered wall formed in a top of the screw head consists of a central region with four lobular grooves extending radially from and continuing from said region to thereby surround the central region, such that each groove is tapered to reduce each groove's width towards a conical bottom disposed in radial direction away from the central region. Each groove is defined with opposite sidewalls facing one another and transmitting torque and with the conical bottom, which connects outer edges of the sidewalls to each other. This configuration enables a deep recess that may be formed in the screw with ultra low head height and able to transmit higher torque for assembling of joints without cam-out.

In FIG. 8A-E, FIG. 8A shows the cross sectional area of the recess drive of the lobular recess drive with tapered wall embodiment, where the sidewall 132 is tapered about 20 degrees with respect to the top surface 16. In this configuration, in comparison with FIG. 2A, FIG. 8A shows a deeper recess depth 156 that is deeper relative to the thinner head height 154, relative to the shank size 158 of the screw size 152. The head to shank ratio is different and improved in this configuration. FIG. 8B shows the top perspective view. The outer lobes channel 48 are tapered at 20 degrees from the top surface 16 and joint outer lobes 15 in the bottom as shown in FIG. 8C. The inner lobes channel 44 are tapered at 5 degrees from the top surface 16 and joint inner lobes 17 in the bottom of the recess and further tapered conically towards the end point 28 as shown in FIG. 8D. The purpose of outer and inner lobes channels are tapered at 20 degrees and 5 degrees are to maximize the volume of material at the head and shank area of the screw to having higher breaking torque and having a smooth tapered channels with uniform offset in geometry and feasibility to manufacture tools, gages and drive bits. FIG. 8E shows a three dimensional view of the inner and outer walls of each recess channel curves in accordance with an embodiment of the invention.

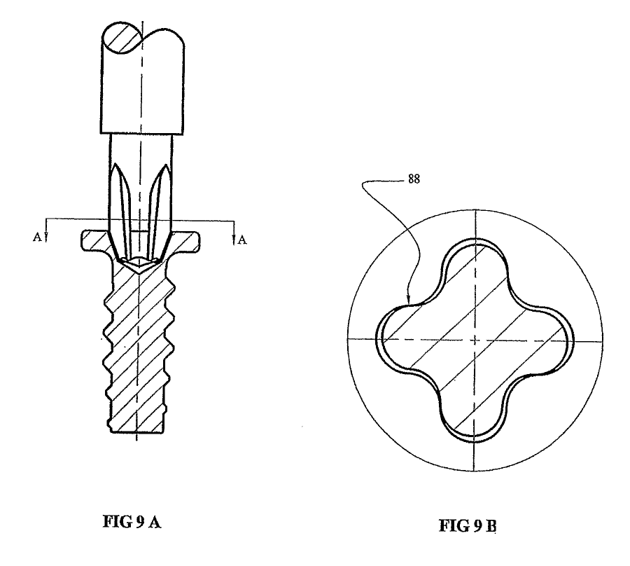

FIG. 9A-B, is a cross-sectional view of the screw 10 of FIG. 8A and recess having tapered walls 132 with engaged driver bits, where the depth of recess protrude to a maximum limits up to the shank of the screw 10 where it does not limit the recess drive to be applied for screw with thin head height thus maintaining higher breaking torque.

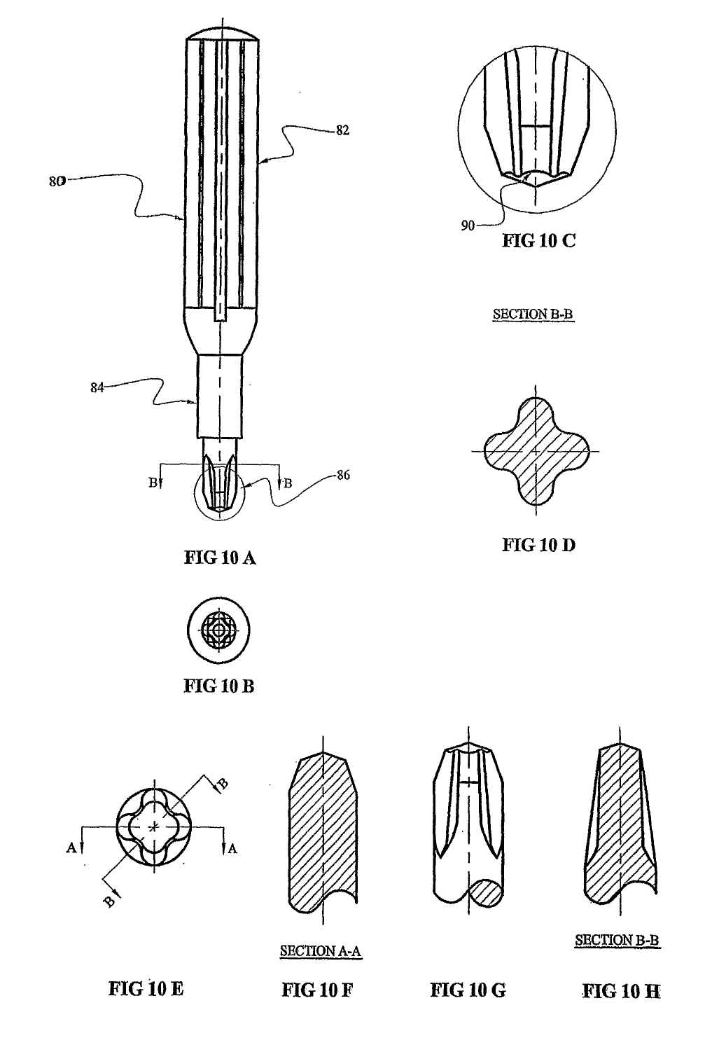

FIG. 10A-H shows a driver tool 80 having handle 82 and shank 84 and a complementary driving contact 86 of the driver tool 80. Point 90 has a taper end surface for engagement on the recess to transmit torque for engage and disengagement with the screw drive head of FIG. 8A. FIG. 10E shows a bottom perspective view of the driving contact surface of the driver tool. FIG. 10D is a cross-section of the shank taken along B-B in FIG. 10A. FIGS. 10F and H are cross-sections of the shank taken along lines A-A and B-B, respectively, in FIG. 10E.

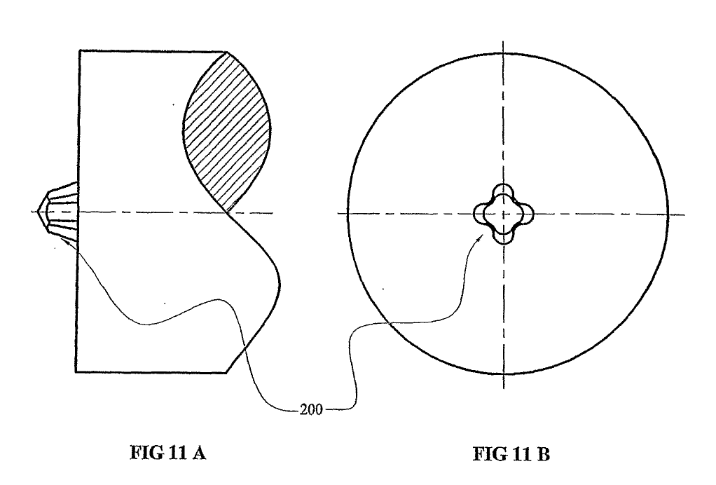

FIGS. 11A and B show a solid recess punch 200 having tapered surface.

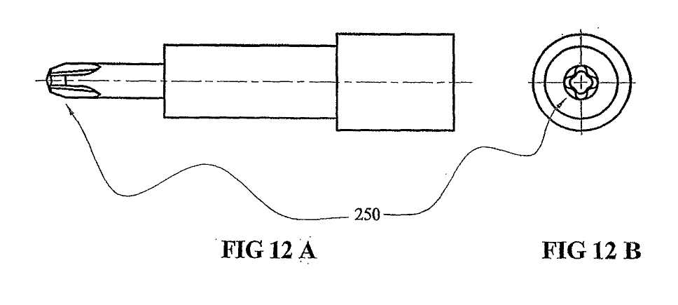

FIGS. 12A and B show the recess gauge 250 for measuring the penetration depth of the lobular recess drive with taper point which are critical for engagement of driver bit and transmission of torque.

A screw recess drive and associated tool which is disclosed that is both easy and inexpensive to manufacture as well providing wide verities of drive system options for component designers to optimize their product and service performance. The embodiments described here also results in more reliable assembly and reduce assembly time. This includes of drive system with lobular recess drives with a plurality of lobes, for example four lobes, and having zero drive angle for effective driver bits and recess engage which prevent from recess and driver stripping during assembly. With this configuration, the possibility of a drive tool camming out of engagement with the screw is reduced. Additionally, a fastener with a recess depth and head height resulting in high head breaking torque is achieved.

Whilst there has been described in the foregoing description preferred embodiments of the present invention, it will be understood by those skilled in the technology concerned that many variations or modifications in details of design or construction may be made without departing from the present invention.

1. A fastener comprising:
a head, the head comprising a top surface, a head height, and an axis; and
a drive, the drive comprising a lobular recess centrally aligned with the axis of the head, the recess comprising a recess side wall and a recess bottom surface, the recess further comprising a plurality of recess channels disposed on the top surface of the head and radially aligned and symmetrically arranged with the axis of the head, each channel comprising an outer lobe of the recess side wall and an inner lobe of the recess side wall between each adjacent outer lobe continuously and smoothly forming the recess side wall, each outer and inner lobe comprising a constant radius of curvature, the recess comprising a recess depth extending along a surface of the recess side wall from the top surface of the head to a point meeting the bottom surface of the recess, and the head height being less than the depth of the recess.

2. (canceled)

3. A fastener as claimed in claim 1 wherein the surface of recess side wall is substantially perpendicular with the top surface of the drive head.

4. A fastener as claimed in claim 1 wherein the surface of recess side wall is tapered with the top surface of the drive head.

5. (canceled)

6. A fastener as claimed in claim 1 wherein the top surface of the head is substantially flat.

7. A fastener as claimed in claim 1 wherein the plurality of recess channels comprises four recess channels.

8. A fastener as claimed in claim 1 a head height to recess depth ratio from the recess side wall to the side wall of the head of the fastener is arranged to maximize breaking torque.

9. A fastener as claimed in claim 1 wherein a head height to recess depth ratio is at least 1:1.

10. (canceled)

11. (canceled)

12. A fastener as claimed in claim 1 wherein the head height is 0.2 mm and the recess depth is 0.28 mm.

13. A fastener as claimed in claim 1 wherein the fastener comprises a shank having a major diameter ranging from 0.4 mm to 2.0 mm, and a respective recess depth ranging from 0.28 mm to 0.80 mm.

14. (canceled)

15. (canceled)

16. A torque-producing driver tool for operating a fastener comprising a head, the head comprising a top surface, a head height, and an axis; and a drive, the drive comprising a lobular recess centrally aligned with the axis of the head, the recess comprising a recess side wall and a recess bottom surface, the recess further comprising a plurality of recess channels disposed on the top surface of the head and radially aligned and symmetrically arranged with the axis of the head, each channel comprising an outer lobe of the recess side wall and an inner lobe of the recess side wall between each adjacent outer lobe continuously and smoothly forming the recess side wall, each outer and inner lobe comprising a constant radius of curvature, the recess comprising a recess depth along a surface of the recess side wall from the top surface of the head to a point meeting the bottom surface of the recess, and the head height being less than the depth of the recess, the tool comprising:
a handle; and a shank having a first end and a second end, the first end of the shank connected to the handle, and the second end of the shank having cross sectional signature substantially complementary in size and shape to the recess of the drive of the head of the fastener for matable engagement with the recess drive of the fastener.

17. The driver tool of claim 16 wherein the driver tool is arranged to have a zero degree drive angle when in engagement with the recess drive of the fastener.

18. A recess punch for manufacturing a fastener comprising a head, the head comprising a top surface, a head height, and an axis; and a drive, the drive comprising a lobular recess centrally aligned with the axis of the head, the recess comprising a recess side wall and a recess bottom surface, the recess further comprising a plurality of recess channels disposed on the top surface of the head and radially aligned and symmetrically arranged with the axis of the head, each channel comprising an outer lobe of the recess side wall and an inner lobe of the recess side wall between each adjacent outer lobe continuously and smoothly forming the recess side wall, each outer and inner lobe comprising a constant radius of curvature, the recess comprising a recess depth along a surface of the recess side wall from the top surface of the head to a point meeting the bottom surface of the recess, and the head height being less than the depth of the recess, the recess punch comprising:
a punch holder; and a punch pin having a first end and a second end, the first end of the punch pin for having a cross-sectional signature substantially complementary in size and shape to the recess the drive of the head of the fastener for punching the recess into the head of the fastener to manufacture the recess drive of the fastener.

19. A recess punch as claimed in claim 18 wherein the second end of the punch pin is integral with the punch holder.

20. A recess punch as claimed in claim 18 wherein the punch holder has a receiving aperture for receiving the punch pin wherein the punch pin is slidebly engaged with the punch holder through the receiving aperture.

21. A fastener as claimed in claim 1 wherein the fastener further comprises a shank having a shank size with a diameter that is less than the distance between the outer lobe extremity to another opposite outer lobe extremity of the recess.
